(19) United States
(12) Patent Application Publication
(10) Pub. No.: US 2019/0111657 A1
(43) Pub. Date: Apr. 18, 2019

(54) CONTROLLING OPTICAL PROPERTIES AND STRUCTURAL STABILITY OF PHOTONIC STRUCTURES UTILIZING IONIC SPECIES

(71) Applicant: President and Fellows of Harvard College, Cambridge, MA (US)

(72) Inventors: Joanna AIZENBERG, Boston, MA (US); Tanya SHIRMAN, Arlington, MA (US); Elijah SHIRMAN, Arlington, MA (US); Katherine Reece PHILLIPS, Cambridge, MA (US); Theresa M. KAY, South Stoney Creek (CA); Hayley C. WHELAN, Charlottetown (CA)

(21) Appl. No.: 16/089,837

(22) PCT Filed: Mar. 31, 2017
(86) PCT No.: PCT/US17/25437

§ 371 Date: Sep. 28, 2018

Related U.S. Application Data
(60) Provisional application No. 62/316,146, filed on Mar. 31, 2016.

(51) Int. Cl. B32B 5/16; B01J 35/00; G02B 1/00

(52) U.S. Cl. CPC B32B 5/16; G02B 1/005; B01J 35/004

(57) ABSTRACT

The present invention relates to photonic structures and methods of controlling the optical properties and structural stability of photonic structures by using ionic species. The photonic structure is less crystalline when increasing concentrations of the ionic species are used. In certain embodiments, the ionic species is a transition metal salt. The method allows for production of single crystalline, polycrystalline, or glass-like photonic structures. The method allows for control of the optical properties and structural stability of photonic structures. The resulting photonic structures are useful in a wide range of applications, including sensors, photoactive catalysts, light emitters, and random lasing.

### RELATED APPLICATIONS

This application claims the benefit of priority to co-pending U.S. Provisional Application Ser. No. 62/316,146, filed Mar. 31, 2016, the contents of which is incorporated by reference.

### COPYRIGHT NOTICE

This patent disclosure may contain material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

### INCORPORATION BY REFERENCE

All patents, patent applications and publications cited herein are hereby incorporated by reference in their entirety in order to more fully describe the state of the art as known to those skilled therein as of the date of the invention described herein.

### FIELD OF THE INVENTION

The present application relates to photonic structures. More particularly, the present application relates to controlling the optical properties and structural stability of photonic structures by utilizing ionic species.

### BACKGROUND

The use of colored chemical pigments exhaustively abounds in everyday life and is the predominant method for achieving colors ranging the entire visible spectrum. However, such organic pigments have potential toxicity as well as bleaching tendencies over longer periods of use.

Photonic crystals demonstrate strong, adjustable color originating from the geometry of the system (so-called, structural color) and are thus, a potential candidate for use as pigments.

### SUMMARY

The present invention relates to photonic structures and methods of controlling the optical properties and structural stability of photonic structures by using ionic species.

In one aspect, the present invention relates to a process comprising: combining a colloidal particle, a matrix material precursor, and an ionic species in a liquid to form a mixture, wherein the ionic species is dispersed or solubilized in the matrix material precursor; and converting the mixture to a solid to form a photonic structure comprising a matrix that includes a matrix material surrounding said colloidal particle.

In certain embodiments, said matrix comprises said ionic species.

In certain embodiments, said matrix comprises precipitates of said ionic species.

In certain embodiments, said liquid is aqueous or organic.

In certain embodiments, said converting comprises hydrolyzing.

In certain embodiments, said matrix material precursor comprises a metal oxide or mixed-metal oxide.

In certain embodiments, said metal oxide comprises a silicon oxide, an aluminum oxide, a titanium oxide, a zirconium oxide, or a cerium oxide.

In certain embodiments, said matrix material precursor comprises a hydrolysable compound.

In certain embodiments, said hydrolysable compound comprises tetraethylorthosilicate (TEOS).

In certain embodiments, said colloidal particle comprises a polymeric colloid, a ceramic colloid, a metallic colloid, a biopolymer colloid, or a supramolecular self-assembled colloid.

In certain embodiments, said colloidal particle comprises a polymeric colloid.

In certain embodiments, said polymeric colloid comprises a polystyrene or poly(methyl methacrylate) colloid.

In certain embodiments, the concentration of ionic species is between 0.1 and 100 mol % of said matrix material surrounding said colloidal particle, wherein the mol % refers to the molecular ratio between the ionic species and the repeating molecular unit of the matrix material.

In certain embodiments, the concentration of ionic species is between 1 and 50 mol % of said matrix material surrounding said colloidal particle.

In certain embodiments, the concentration of ionic species is between 5 and 20 mol % of said matrix material surrounding said colloidal particle.

In certain embodiments, said photonic structure is single crystalline.

In certain embodiments, said photonic structure is less crystalline with increasing concentration of said ionic species.

In certain embodiments, said photonic structure is polycrystalline.

In certain embodiments, said photonic structure is glass-like.

In certain embodiments, said photonic structure is crack free.

In certain embodiments, said photonic structure is formed within a droplet.

In certain embodiments, the droplet is between 0.1 μm and 10 mm.

In certain embodiments, the droplet is between 1 μm and 10 mm.

In certain embodiments, the droplet is between 1 μm and 1 mm.

In certain embodiments, said photonic structure is spectrally modified, color saturated, iridescent, or exhibits controllable angle-dependent optical properties.

In certain embodiments, said controllable angle-dependent optical properties comprise spectral shifts, color travel, sparkle, hue, glare, gloss, or luster.

In certain embodiments, said ionic species is a metal salt.

In certain embodiments, said metal salt is a transition metal salt.

In certain embodiments, said transition metal salt comprises a cobalt salt, a nickel salt, a copper salt, a manganese or mixtures thereof.

In certain embodiments, said transition metal salt comprises cobalt nitrate, nickel sulfate, copper nitrate, or mixtures thereof.

In certain embodiments, said metal salt comprises a magnesium salt.

In certain embodiments, said magnesium salt comprises magnesium sulfate.

In certain embodiments, said photonic structure is useful in catalysis.

In another aspect, the present invention relates to a photonic structure comprising: a first component and a matrix component, wherein said matrix component comprises dispersed or solubilized ionic species.

In certain embodiments, said first component is a gas.

In certain embodiments, said first component is a colloidal particle.

In certain embodiments, said colloidal particle comprises a polymeric colloid, a ceramic colloid, a metallic colloid, a biopolymer colloid, or a supramolecular self-assembled colloid.

In certain embodiments, said colloidal particle comprises a polymeric colloid.

In certain embodiments, said polymeric colloid comprises a polystyrene or poly(methyl methacrylate) colloid.

In certain embodiments, the concentration of said ionic species is between 0.1 and 100 mol % of said matrix component.

In certain embodiments, the concentration of said ionic species is between 1 and 50 mol % of said matrix component.

In certain embodiments, the concentration of said ionic species is between 5 and 20 mol % of said matrix component.

In certain embodiments, said photonic structure is single crystalline.

In certain embodiments, said photonic structure is polycrystalline.

In certain embodiments, said photonic structure is glass-like.

In certain embodiments, said photonic structure is crack free.

In certain embodiments, said photonic structure is spectrally modified, color saturated, iridescent, or exhibits controllable angle-dependent optical properties.

In certain embodiments, said controllable angle-dependent optical properties comprise spectral shifts, color travel, sparkle, hue, glare, gloss, or luster.

In certain embodiments, said matrix component further comprises a metal oxide or mixed-metal oxide.

In certain embodiments, said metal oxide comprises a silicon oxide, an aluminum oxide, a titanium oxide, a zirconium oxide, or a cerium oxide.

In certain embodiments, said metal oxide comprises a hydrolysable compound.

In certain embodiments, said hydrolysable compound comprises tetraethylorthosilicate (TEOS).

In certain embodiments, said ionic species is a metal salt.

In certain embodiments, said metal salt is a transition metal salt.

In certain embodiments, said transition metal salt comprises a cobalt salt, a nickel salt, a copper salt, a manganese salt, or mixtures thereof.

In certain embodiments, said transition metal salt comprises cobalt nitrate, nickel sulfate, copper nitrate, or mixtures thereof.

In certain embodiments, said metal salt comprises a magnesium salt.

In certain embodiments, said magnesium salt comprises magnesium sulfate.

In certain embodiments, said photonic structure is useful in structural pigments, electromagnetic filters, sensors, photoactive catalysts, coherent scattering media, light emitters, random lasing, or other optical applications, such as smart displays or other electrochromic materials.

In certain embodiments, said photonic structure is useful for the preparation of cosmetic, pharmaceutical and edible products.

In certain embodiments, said photonic structure is useful in drug delivery, fluidic devices, tissue engineering, membranes, filtration, sorption/desorption, or support medium.

In certain embodiments, said photonic structure is useful as a catalytic medium or support.

In certain embodiments, said photonic structure is useful in energy storage, batteries, or fuel cells.

In certain embodiments, said photonic structure is useful in acoustic devices.

In certain embodiments, said photonic structure is useful in fabrication of patterned structures.

### BRIEF DESCRIPTION OF THE DRAWINGS

The above and other objects and advantages of the present invention will be apparent upon consideration of the following detailed description, taken in conjunction with the accompanying drawings, in which like reference characters refer to like parts throughout, and in which:

FIGS. 1A-1C are schematics of different photonic structures, in accordance with certain embodiments.

FIG. 1D is a schematic representation of a two-dimensional single crystalline hexagonal lattice and its radial distribution function (RDF), in accordance with certain embodiments. The RDF of the lattice comprises a progression of peaks corresponding to the lattice's characteristic distances. The first five peaks are designated as a-e. Higher orders appear with the additional number. For example, the second order of “a” appears as “2a.”

FIGS. 1E-1G are schematics of different photonic structures, in accordance with certain embodiments. FIG. 1E shows single crystalline (1), polycrystalline (2), and glass-like (3) structures of densely packed spheres of the same size. FIG. 1F shows the corresponding Fourier Transforms. FIG. 1G shows the RDFs generated based on the analysis of the schematic images.

FIG. 1H is a flow chart of a photonic structure co-assembly method, in accordance with certain embodiments.

FIGS. 2A-2C are scanning electron microscopy (SEM) images of exemplary spherical photonic structures that have been self-assembled in spherical droplets of various sizes (i.e., 225 nm, 415 nm, and 1060 nm, respectively), in accordance with certain embodiments.

FIGS. 3A-3C are SEM images of exemplary inverted spherical photonic structures that have been self-assembled in spherical droplets of various sizes, in accordance with certain embodiments. A second material was added to occupy the interstitial sites, creating inverse opal microspheres with an inorganic matrix (e.g., silica (FIG. 3A) and titania (FIG. 3B)) and a polymeric matrix consisting of water soluble poly(vinyl-pyrrolidone) (FIG. 3C).

FIGS. 4A-4F are SEM images of photonic microspheres with varying concentrations of added cobalt nitrate (0 mM, 0.1 mM, and 0.2 mM), in accordance with certain embodiments. FIGS. 4A and 4B correspond to the 0 Mm concentration, FIGS. 4C and 4D correspond to the 0.1 Mm concentration, and FIGS. 4E and 4F correspond to the 0.2 Mm concentration.

FIGS. 5A-5C are diagrams of inverse opal powders loaded with Co(NO₃)₂, in accordance with certain embodiments. FIG. 5A shows inverse opal powders loaded with increasing amounts of cobalt (i.e., 0 mM Co(NO₃)₂, 0.64 mM Co(NO₃)₂, and 1.28 mM Co(NO₃)₂), resulting in an increased color saturation of the samples as shown by improved visibility of the samples on white backgrounds. FIGS. 5B and 5C show the structural and chemical analysis of the sample containing 0.64 mM Co(NO₃)₂ (i.e., cobalt is 10 mol %, wherein the mol % refers to the molecular ratio between the ionic species and the repeating molecular unit of the matrix material in the final solid matrix) by Transmission Electron Microscopy (TEM) and Scanning Transmission Electron Microscopy-Energy Dispersive Spectroscopy (STEM-EDS) elemental composition. STEM-EDS indicated that within the resolution of the microscope cobalt, silicon, and oxygen were homogeneously distributed within the matrix.

FIGS. 6A-6C are diagrams of inverse opal powders with incorporation of Co(NO₃)₂, in accordance with certain embodiments. FIG. 6A shows SEM images of samples containing increasing amounts of cobalt (i.e., 0 mM Co(NO₃)₂, 0.64 mM Co(NO₃)₂, and 1.28 mM Co(NO₃)₂). FIG. 6B shows Fourier Transforms of the SEM images. FIG. 6C shows the RDFs calculated based on the SEM image analysis.

FIGS. 7A-7C are diagrams of inverse opal powders with incorporation of NiSO₄, Cu(NO₃)₂, or MgSO₄ in accordance with certain embodiments. FIG. 7A shows SEM images of samples containing 0 mM NiSO₄, Cu(NO₃)₂, or MgSO₄; 0.64 mM NiSO₄; 1.28 mM NiSO₄; 0.64 mM Cu(NO₃)₂; 1.3 mM Cu(NO₃)₂; 0.64 mM MgSO₄, and 1.3 mM MgSO₄. FIG. 7B shows Fourier Transforms of the SEM images. FIG. 7C shows RDFs calculated based on the SEM image analysis.

### DETAILED DESCRIPTION

Structural color pigments based on such materials as silica, titania, zirconia and alumina are highly desirable due to their remarkable chemical-, thermal- and photo-stability, as well as their biocompatibility. Aspects of the color properties of structural color pigments (e.g., the degree of iridescence, sparkle/glitter effects, and color travel on a macroscopic scale from a painted surface or volume) can be modified by controlling angular dependence. For example, color travel is an alteration of the frequency of the reflected light as a function of the relative angle between the light source and the observer.

Photonic structures can be useful in any application where light is manipulated, including in sensors, photoactive catalysts, and light emitters. Control over the optical properties of photonic structures used in these applications is critical, and often a photonic crystal with more disorder is preferable. For example, limiting the angular dependence of the reflected light in photonic crystal-based sensors allows users to simplify the visual assessment and/or to automate the assessment related to the changes resulting from different stimuli. Similarly, since photocatalysts accelerate photo-induced reactions, when a photocatalyst is embedded in a photonic crystal, manipulating the angular dependence of the photonic band-gap of the photonic crystal can amplify the photo-induced activity of the photocatalyst. When highly ordered photonic crystals are used, the response is only amplified for a limited range of angles, whereas when a less ordered photonic crystal is used, the response is amplified at a broad range of angles. Similarly, another benefit of a lower degree of order in a photonic crystal is that light is more efficiently trapped within the photonic crystal because there is more internal reflection and scattering within the structure. This is useful for photonic structures used in light emitters.

Additionally, photonic crystals, particularly less ordered photonic crystals, are useful in applications such as random lasing. For example, Anderson localization is a phenomenon that occurs in random lasing where the electrons become trapped in the metallic structure due to disorder, resulting in the metal changing phase from a conductor to an insulator. Similarly, coherent backscattering is a phenomenon that occurs in random lasing where the light from the laser is scattered repeatedly due to the numerous scattering centers of the disordered photonic crystal.

The present application relates to photonic structures and methods of controlling the optical properties and structural stability of photonic structures by using ionic species. In certain embodiments, by introducing a desired ionic species, the photonic structure can exhibit single crystalline, polycrystalline or even glass-like ordering that affects the optical properties and structural stability of the photonic structures.

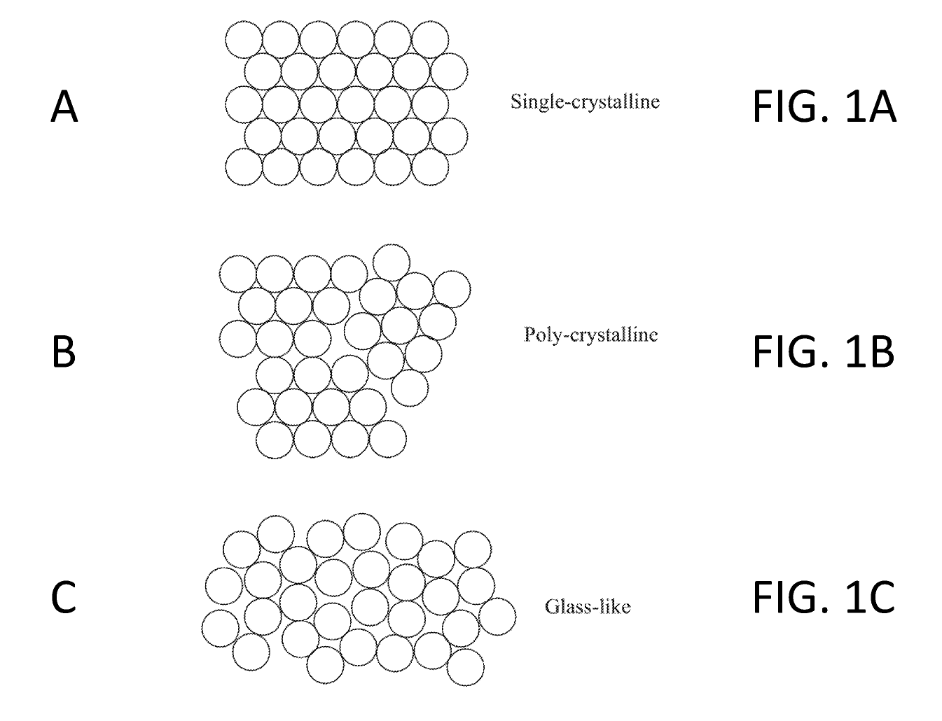

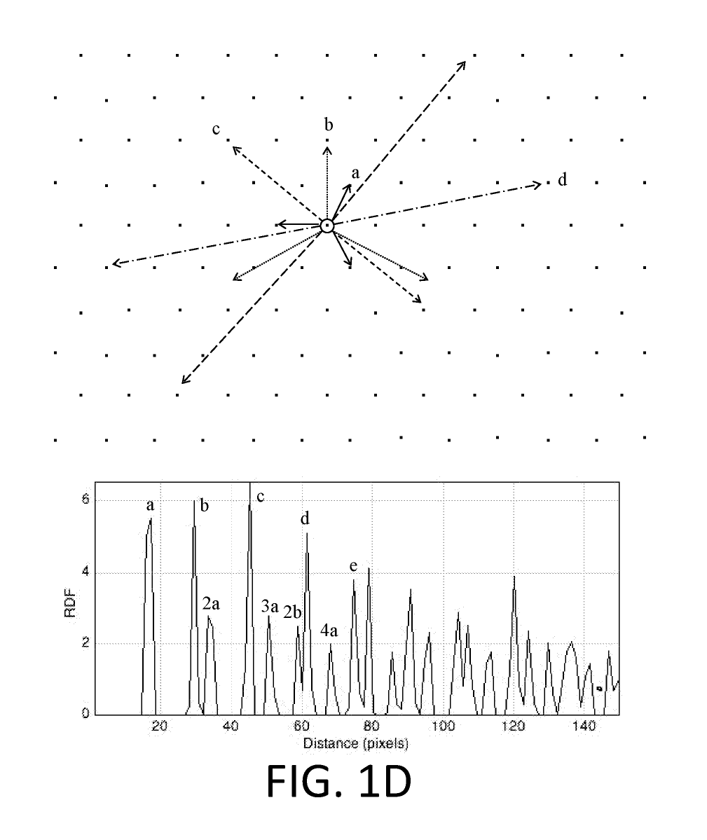

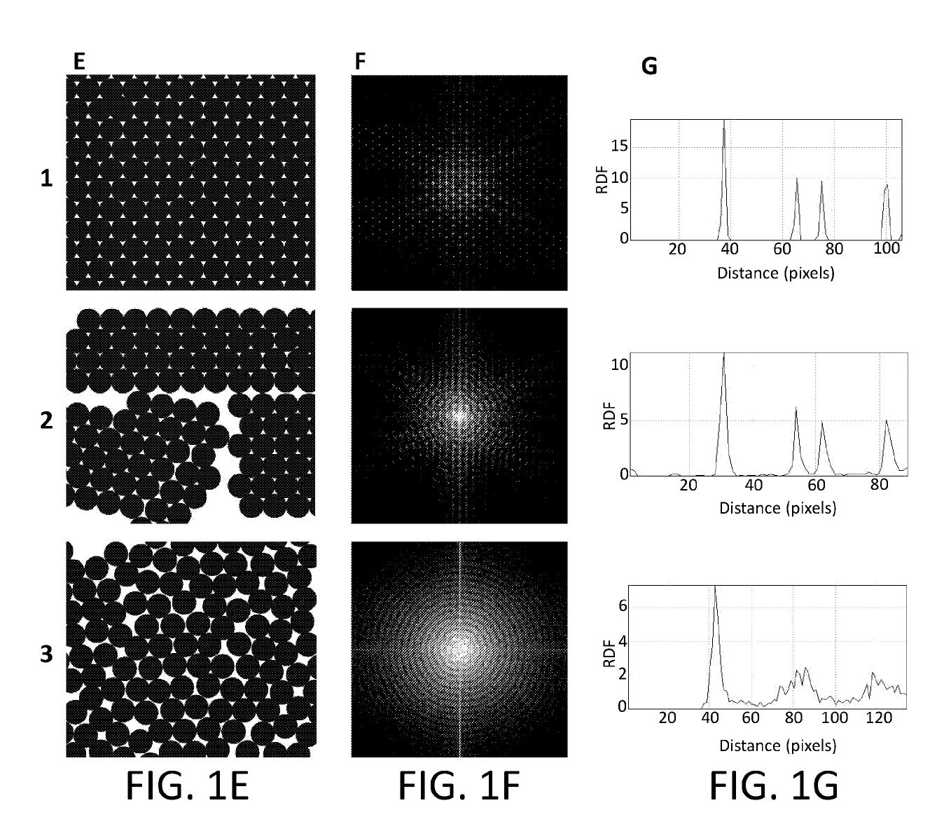

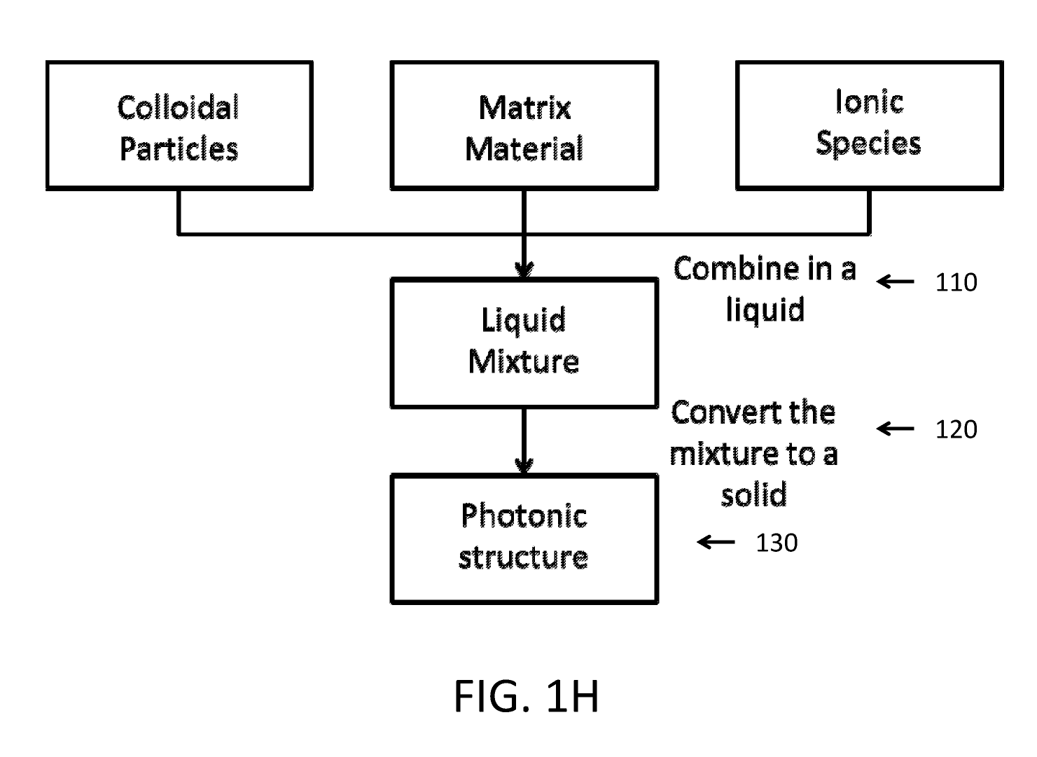

As discussed herein, radial distribution function (RDF) can be utilized to determine whether a material is single crystalline, polycrystalline or glass-like. RDF is constructed by drawing a series of concentric circular shells around each lattice point and determining the density of particles found in each shell as a function of distance from the reference points. A well-ordered system will have resolved peaks corresponding to characteristic distances between lattice points as shown in FIG. 1D. Increasing degree of disorder in a densely packed arrangement of equal spheres will be characterized by widening of the peaks, decreasing resolution between the peaks, and consequently decrease in the intensity of the peaks in the RDF plot. The first peak corresponding to the shortest characteristic distance in such systems (e.g., the diameter of the spheres) will always be present. Simplified models of the single-crystalline, polycrystalline, and glass-like systems, and the corresponding Fourier Transforms and RDF analyses are shown in FIGS. 1E-G. The Fourier Transform and RDF results for various model and experimental systems can be compared qualitatively and quantitatively.

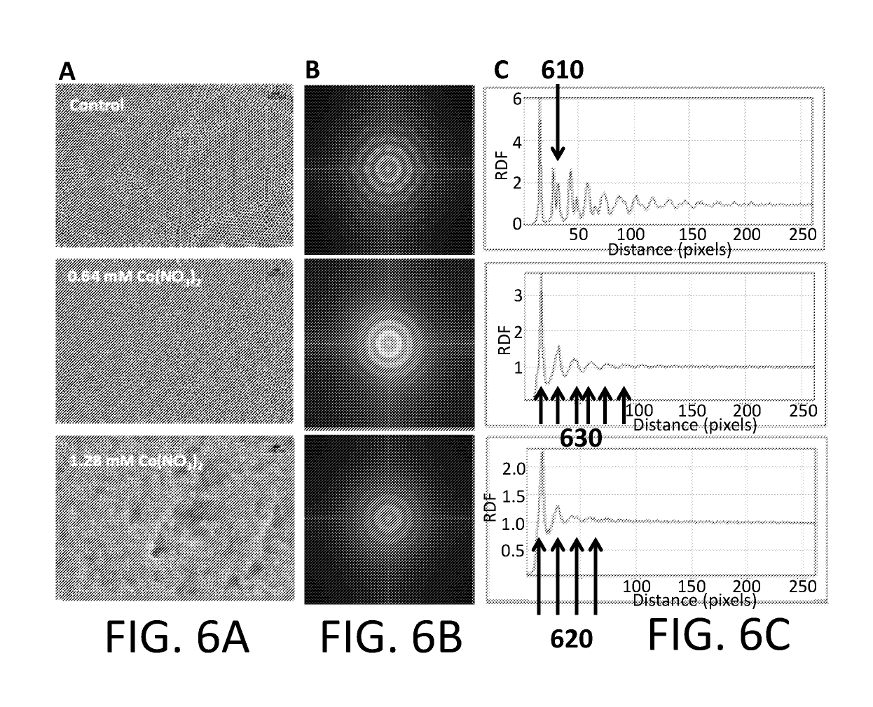

The term “single crystalline,” as used herein, can be determined utilizing a radial distribution function. Examples of the characteristic distances in a two-dimensional hexagonal lattice and the corresponding peaks in the RDF plot are shown in FIG. 1D. For example, the second order peak (designated as 2a) is accompanied by an additional peak (designated as b). These two peaks can be easily distinguished on the RDF of the control sample. For example, as shown in FIG. 6C, the second major peak 610 in the radial distribution function of the sample may exhibit a doublet peak.

The term “glass-like,” as used herein, can be determined utilizing a radial distribution function. Glass-like systems will exhibit a distinct peak corresponding to the distance between the adjacent particles (or pores) in the material, while peaks corresponding to longer distances will start overlapping and will be poorly resolved. In general, the radial distribution function for a highly disordered system will show a fast decay of the peaks' intensity as a function of distance and has five or fewer dominant peaks. For example, the 1.28 mM Co(NO₃)₂ sample shown in FIG. 6C has four clearly identifiable peaks (620).

The term “polycrystalline,” as used herein, means a structure that behaves as a material in between a single crystalline structure and a glass-like structure. A polycrystalline structure can be determined utilizing a radial distribution function. Polycrystalline systems may have distinctive RDF peaks for small repeating distances between lattice points. Peaks corresponding to greater distances will be poorly resolved due to the variation in particle separation across domain interfaces. The peaks calculated in FIG. 1G can be identified similarly for the polycrystalline model system and the single crystalline system. However, the polycrystalline peaks are wider and less intense. In general, the RDF of a polycrystalline system can show five or more dominant peaks. For example, the 0.64 mM Co(NO₃)₂ sample shown in FIG. 6C has five or more peaks (see 630) and the second peak is not a clearly resolved doublet as compared to the control sample.

1. Photonic Structures

FIGS. 1A-1C show schematics of different photonic structures. For instance, FIG. 1A shows a schematic illustration of a single-crystalline photonic structure. FIG. 1B shows a schematic illustration of a polycrystalline photonic structure. FIG. 1C shows a schematic illustration of a glass-like photonic structure.

In certain embodiments, the photonic structure can comprise colloidal particles arranged in a single crystalline, polycrystalline or glass-like ordering.

In certain embodiments, the colloidal particles can be surrounded with a matrix. In certain embodiments, the colloidal particles can be removed leaving a matrix material surrounding empty pores.

In certain embodiments, the matrix can further include ionic species and/or precipitates of the ionic species. As described more fully below, the incorporation of ionic species during fabrication of the photonic structures may give rise to desired optical properties and/or structural stability.

Some exemplary structures include “direct opal” structures in which colloidal particles are arranged in single-crystalline, polycrystalline or glass-like structures. Some other exemplary structures include “inverse opal” structures in which the colloidal particles are removed to form empty pores. Some other exemplary structures include “compound opals” wherein colloidal particles are present as well as the matrix component.

In certain embodiments, the photonic structures include a self-assembled structure of colloidal particles.

In certain embodiments, the photonic structure exhibits a crack-free structure. In certain embodiments, the photonic structure exhibits a crack-free domain that exceeds 2 μm. In certain embodiments, the photonic structure exhibits a crack-free domain that exceeds 5 μm. In certain embodiments, the photonic structure exhibits a crack-free domain that exceeds 10 μm. In certain embodiments, the photonic structure exhibits a crack-free domain that exceeds 0.1 mm. In certain embodiments, the photonic structure exhibits a crack-free domain that exceeds 1 mm.

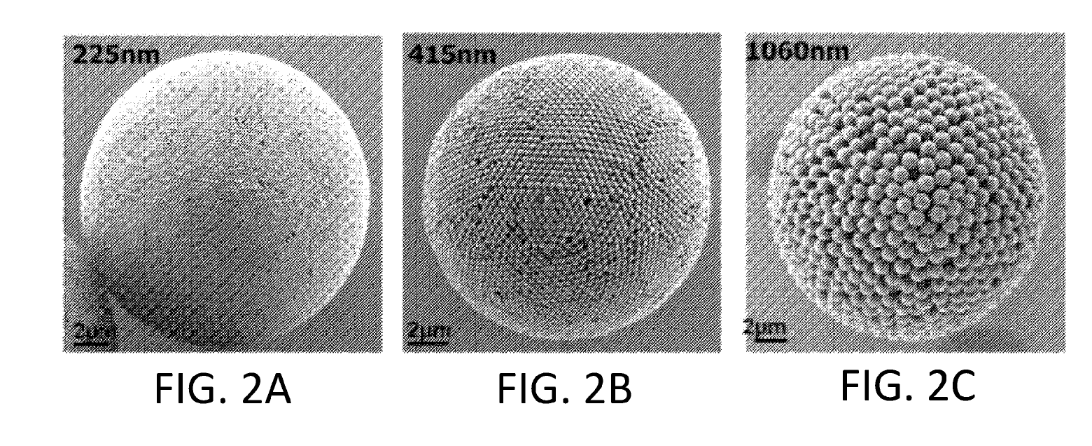

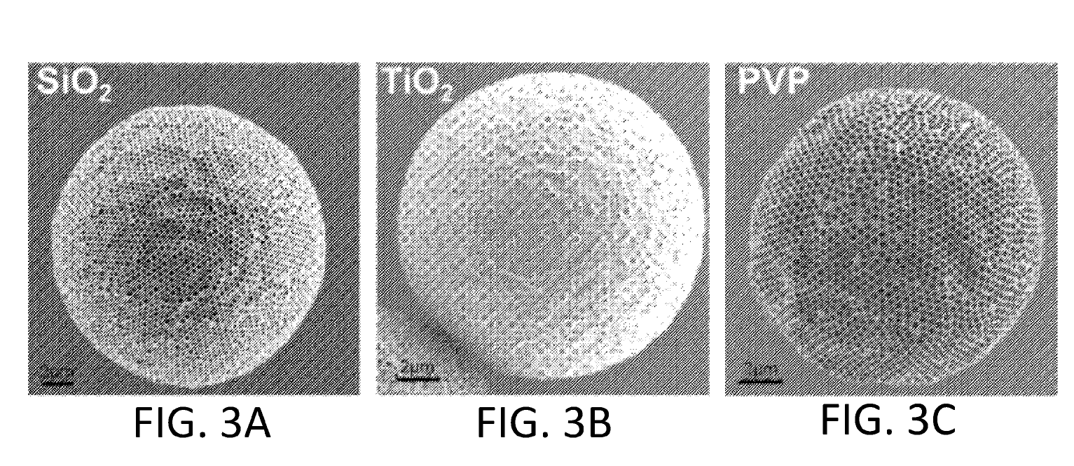

In certain embodiments, the photonic structures can be arranged in various different shapes. For instance, the photonic structure can be arranged within a droplet to result in a spherical shape as shown in FIGS. 2A-2C and FIGS. 3A-3C. FIGS. 2A-2C show some exemplary direct opal structures (without ionic species), while FIGS. 3A-3C show inverse opal structures (without ionic species). In certain embodiments, the droplet size is between 0.1 μm to 10 mm. In certain embodiments, the droplet size is between 1 μm and 10 mm. In certain embodiments, the droplet size is between 1 μm and 1 mm. In certain embodiments, the droplet size is between 10 μm and 10 mm.

In certain embodiments, the photonic structure includes an inverse opal photonic structure that exhibits a blue color. Such photonic structures can be formed, for example, through the incorporation of certain cobalt or copper compounds into a silicon oxide matrix using the co-assembly of the colloidal dispersion and the silica sol-gel, nano-crystalline, or mixed precursors, containing the metal salts.

2. Colloidal Particles

In certain embodiments, the colloidal particles comprise ceramic colloids. In certain embodiments, the colloidal particles comprise metallic colloids. In certain embodiments, the colloidal particles comprise biopolymer colloids. In certain embodiments, the colloidal particles comprise supramolecular self-assembled colloids.

In certain embodiments, the colloidal particles are sterically-stabilized. In certain embodiments, the colloidal particles are charge-stabilized. In certain embodiments, the colloidal particles are sterically- and charge-stabilized. In certain embodiments, the colloidal particles are polymeric colloids. In certain embodiments, the polymeric colloids are PVP-stabilized sub-micrometer polystyrene colloidal particles. In certain embodiments, the polymeric colloids are PEG-stabilized sub-micrometer polystyrene colloidal particles. In certain embodiments, the PEG-stabilized sub-micrometer polystyrene colloidal particles are PEG-stabilized 244 nm polystyrene colloidal particles.

Many different types of colloidal particles can be utilized. The colloids can be made from various materials or mixtures of materials. In certain embodiments, the materials are metals, such as gold, palladium, platinum, silver, copper, rhodium, ruthenium, rhenium, titanium, osmium, iridium, iron, cobalt, nickel and combinations thereof. In certain embodiments, the materials are semiconductor materials, such as silicon, germanium, tin, silicon doped with group III or V elements, germanium doped with group III or V elements, tin doped with group III or V elements, and combinations thereof. In certain embodiments, the materials include catalysts for chemical reactions. In certain embodiments, the materials are oxides, such as silica, alumina, beryllia, noble metal oxides, platinum group metal oxides, titania, zirconia, hafnia, molybdenum oxides, tungsten oxides, rhenium oxides, tantalum oxides, niobium oxides, chromium oxides, scandium oxides, yttria, lanthanum oxides, ceria, rare earth oxides, thorium oxides, uranium oxides, and combinations thereof. In certain embodiments, the materials are metal sulfides, metal chalcogenides, metal nitrides, metal pnictides, and combinations thereof. In certain embodiments, the materials are organometallic compounds, including various metal organic frameworks (MOFs), inorganic polymers (such as silicones), organometallic complexes, and combinations thereof. In certain embodiments, the colloids are made from organic materials, including polymers, natural materials, and mixtures thereof. In certain embodiments, the material is polymeric, including poly(methyl methacrylate) (PMMA), other polyacrylates, other polyalkylacrylates, substituted polyalkylacrylates, polystyrene (PS), poly(divinylbenzene), poly(vinylalcohol) (PVA), polyvinylpyrrolidone (PVP), and hydrogels. Other polymers of different architectures can be utilized as well, such as random and block copolymers, branched, star and dendritic polymers, and supramolecular polymers. In certain embodiments, the material is natural, including protein- or polysaccharide-based materials, silk fibroin, chitin, shellac, cellulose, chitosan, alginate, gelatin, and mixtures thereof.

3. Matrix Precursor

In certain embodiments, the matrix of the photonic structure is formed from a matrix precursor. In certain embodiments, the matrix precursor contains a ceramic material. In certain embodiments, the matrix precursor is a ceramic material. In certain embodiments, the matrix precursor contains a semiconductor material. In certain embodiments, the matrix precursor is a semiconductor material. In certain embodiments, the matrix precursor contains a metal oxide. In certain embodiments, the matrix precursor is a metal oxide.

In certain embodiments, the matrix precursor contains an alumina-based component. In certain embodiments, the matrix precursor is alumina-based. In certain embodiments, the matrix precursor contains a silica-based component. In certain embodiments, the matrix precursor is silica-based. In certain embodiments, the matrix precursor is tetraethylorthosilicate. In certain embodiments, the matrix precursor contains a titania-based component. In certain embodiments, the matrix precursor is titania-based. In certain embodiments, the matrix precursor contains a zirconia-based component. In certain embodiments, the matrix precursor is zirconia-based.

In certain embodiments, the matrix precursor contains a sol-gel precursor. In certain embodiments, the matrix precursor is a sol-gel precursor. In certain embodiments, the matrix precursor is prehydrolyzed. In certain embodiments, the prehydrolysis of the matrix precursor is performed by combining it with an alcohol (e.g., methanol or ethanol), an acid (e.g., hydrochloric acid) or base (e.g., sodium hydroxide), and optionally water.

In certain embodiments, the matrix material consists of nano-crystals. In certain embodiments, the nano-crystals are alumina, silica, titania, zirconia, vanadia, yttria, ceria, iron-oxide, zinc oxide, or copper oxide nano-crystals. In certain embodiments, the nano-crystals are 0.5-50 nm. In certain embodiments, the nano-crystals are 1-20 nm.

In certain embodiments, the matrix material consists of a combination of a prehydrolyzed precursor and nano-crystals. In certain embodiments, the prehydrolyzed precursor is a silica, alumina, or titania precursor. In certain embodiments, the nano-crystals are alumina, silica, titania, zirconia, yttria, or ceria nano-crystals.

In certain embodiments, the matrix material can be made from various materials or mixtures of materials. In certain embodiments, the materials include metals, such as gold, palladium, platinum, silver, copper, rhodium, ruthenium, rhenium, titanium, osmium, iridium, iron, cobalt, nickel and combinations thereof. In certain embodiments, the materials include semiconductors, such as silicon, germanium, tin, silicon doped with group III or V elements, germanium doped with group III or V elements, tin doped with group III or V elements, and combinations thereof. In certain embodiments, the materials include catalysts for chemical reactions. In certain embodiments, the materials include oxides, such as silica, alumina, beryllia, noble metal oxides, platinum group metal oxides, titania, zirconia, hafnia, molybdenum oxides, tungsten oxides, rhenium oxides, tantalum oxides, niobium oxides, chromium oxides, scandium oxides, yttria, lanthanum oxides, ceria, rare earth oxides, thorium oxides, uranium oxides, and combinations thereof. In certain embodiments, the materials include metal sulfides, metal chalcogenides, metal nitrides, metal pnictides, and combinations thereof. In certain embodiments, the materials include organometallic compounds, including various metal organic frameworks (MOFs), inorganic polymers (such as silicones), organometallic complexes, and combinations thereof. In certain embodiments, the matrices are made from organic materials, including polymers, natural materials, and mixtures thereof. In certain embodiments, the material is polymeric, including poly(methyl methacrylate) (PMMA), other polyacrylates, other polyalkylacrylates, substituted polyalkylacrylates, polystyrene (PS), poly(divinylbenzene), poly(vinylalcohol) (PVA), polyvinylpyrrolidone (PVP), and hydrogels. Other polymers of different architectures can be utilized as well, such as random and block copolymers, branched, star and dendritic polymers, and supramolecular polymers. In certain embodiments, the material is natural, including protein- or polysaccharide-based materials, silk fibroin, chitin, shellac, cellulose, chitosan, alginate, gelatin, and mixtures thereof.

4. Ionic Species

In certain embodiments, the term “ionic species” includes cationic and/or anionic species.

Exemplary cationic species include Ag^{x+} (x=4,3,2,1), Au^{x+} (x=5,3,2,1), Co^{x+} (x=5,4,3,2,1), Cr^{x+} (x=6,5,4,3,1), Cu^{x+} (x=4,3,2,1), Fe^{x+} (x=6,5,4,3,2,1), Mn^{x+} (x=7,6,5,4,3,1), Mo^{x+} (x=6,5,4,3,1), Pt^{x+} (x=6,5,4,3,2,1), W^{x+} (x=6,5,4,3,1), Zn^{x+} (x=2,1), and other metal cations, complex cations (inorganic and organometallic), onium cations (including NR₄⁺ (e.g., ammonium, pyrrolidinium), onium cations with polyvalent substitutions (including iminium, imidazolium and pyridinium), pyrazolium, thiazolium, PR₄⁺ (phosphonium), and SR₃⁺ (sulfonium), where R can be, e.g., H, CH₃(CH₂)ₙ, or aryl), and other organic cations.

Exemplary anionic species include halides (Cl⁻, Br⁻, I⁻, F⁻), borates (such as BF₄⁻), phosphates (such as PF₆⁻), imides (including bis(trifluoromethyl-sulfonyl)imides), mineral salt anions (including carbonate, nitrate, nitride, sulfate, sulfite), sulfonates (such as alkylsulfonates, tosylate, and methanesulfonate), carboxylates, complex inorganic anions (such as [Al₂Cl₂]⁻), and organometallic anions.

In certain embodiments, the valence state of the ionic species can be changed, which in turn can affect the optical properties and/or structural stability of the photonic structure. For example, valence state can be controlled by controlling the pH, concentration, temperature, presence of redox agents, and/or presence of coordinating species.

In certain embodiments, the number and type of coordinated ligands can affect the optical properties and/or structural stability of the photonic structure.

In certain embodiments, the ionic species are soluble in the matrix material and/or the matrix precursor. In certain embodiments, the ionic species are dispersed in the matrix material and/or the matrix precursor. In certain embodiments, the ionic species is an anionic species. In certain embodiments, the ionic species is a cationic species.

In certain embodiments, the ionic species is a metal salt. In certain embodiments, the metal salt is a transition metal salt. In certain embodiments, the transition metal salt is a nickel salt. In certain embodiments, the transition metal salt is a copper salt. In certain embodiments, the transition metal salt is a cobalt salt. In certain embodiments the transition metal salt is a manganese salt. In certain embodiments, the metal salt is a magnesium salt.

In certain embodiments, the counterion is any simple or complex anionic species. In certain embodiments, the counterion is nitrate. In certain embodiments, the counterion is sulfate. In certain embodiments, the counterion is chloride. In certain embodiments, the counterion is carbonate.

In certain embodiments, the ionic species is an alkali or alkaline earth metal salt (e.g., LiCl, NaCl, KCl, BeCl₂, Be(NO₃)₂, CaSO₄, MgCl₂, Mg(NO₃)₂, MgCO₃, MgSO₄, CaSO₄, Ca(NO₃)₂, CaCl₂, CaCO₃, CaSO₄).

In certain embodiments, the transition metal salt is Co(NO₃)₂. In certain embodiments, the transition metal salt is Cu(NO₃)₂. In certain embodiments, the transition metal salt is NiSO₄. In certain embodiments, the transition metal salt is MnCl₂. In certain embodiments, the transition metal salt is MnSO₄. In certain embodiments, the transition metal salt is CoCl₂. In certain embodiments, the transition metal salt is Fe(NO₃)₃. In certain embodiments, the transition metal salt is CuSO₄. In certain embodiments, the metal salt is MgSO₄.

In certain embodiments, the concentration of the ionic species is chosen to correspond to the volume of the resulting species in the product to be less than the volume occupied by colloids (including their ligands). In certain embodiments, the concentration of the ionic species in the final solid matrix is between 0 and 3.3 mM. In certain embodiments, the concentration of the ionic species in the final solid matrix is between 0 and 1.3 mM. In certain embodiments, the concentration of the ionic species in the final solid matrix is between 0.64 mM and 3.3 mM. In certain embodiments, the concentration of the ionic species in the final solid matrix is between 0.64 mM and 1.3 mM. In certain embodiments, the concentration of the ionic species in the final solid matrix is greater than 0.64 mM. In certain embodiments, the concentration of the ionic species in the final solid matrix is less than 3.3 mM. In certain embodiments, the concentration of the ionic species in the final solid matrix is less than 1.3 mM.

In certain embodiments, the concentration of the ionic species in the final product is between 0 and 100 mol %, wherein the mol % refers to fraction of the total molecular units in the final product (i.e., the final product is referred to as a combination of the ionic species and the repeating molecular unit of the matrix material) of the final solid matrix in respect to the matrix precursor component. In certain embodiments, the concentration of the ionic species in the final solid matrix is between 0 and 50 mol % in respect to the repeating molecular units of the matrix precursor component in the final solid matrix. In certain embodiments, the concentration of the ionic species in the final solid matrix is between 0 and 20 mol % in respect to the repeating molecular units of the matrix precursor component in the final solid matrix. In certain embodiments, the concentration of the ionic species in the final solid matrix is between 0 and 10 mol % in respect to the repeating molecular units of the matrix precursor component in the final solid matrix. In certain embodiments, the concentration of the ionic species in the final solid matrix is between 0.1 and 100 mol % in respect to the repeating molecular units of the matrix precursor component in the final solid matrix. In certain embodiments, the concentration of the ionic species in the final solid matrix is between 1 and 50 mol % in respect to the repeating molecular units of the matrix precursor component in the final solid matrix. In certain embodiments, the concentration of the ionic species in the final solid matrix is between 5 and 20 mol % in respect to the repeating molecular units of the matrix precursor component in the final solid matrix. In certain embodiments, the concentration of the ionic species in the final solid matrix is between 10 and 100 mol % in respect to the repeating molecular units of the matrix precursor component in the final solid matrix. In certain embodiments, the concentration of the ionic species in the final solid matrix is between 10 and 50 mol % in respect to the repeating molecular units of the matrix precursor component in the final solid matrix. In certain embodiments, the concentration of the ionic species in the final solid matrix is between 10 and 20 mol % in respect to the repeating molecular units of the matrix precursor component in the final solid matrix. In certain embodiments, the concentration of the ionic species is 10 mol % in respect to the repeating molecular units of the matrix precursor component in the final solid matrix. In certain embodiments, the concentration of the ionic species is 20 mol % in respect to the repeating molecular units of the matrix precursor component in the final solid matrix. In certain embodiments, the concentration of the ionic species is 50 mol % in respect to the repeating molecular units of the matrix precursor component in the final solid matrix. In certain embodiments, the concentration of the ionic species in the final solid matrix is between 50 and 100 mol %, wherein the mol % refers to fraction of the total molecular units in the final product (i.e., the final product is referred to as a combination of the ionic species and the repeating molecular unit of the matrix material).

In certain embodiments, the ionic species can be distributed into the matrix uniformly. In certain embodiments, the ionic species can precipitate out during fabrication and may remain in the matrix of the photonic structure as precipitates. The precipitates may range from sub-nanometer to 50 nm in size. Some exemplary precipitates include metal oxides, ionic precipitates, metals, polymers, supramolecular precipitates and mixtures thereof.

In certain embodiments, nickel can be incorporated into the matrix. In certain embodiments, manganese can be incorporated into the matrix. In certain embodiments, cobalt can be incorporated into the matrix. In certain embodiments, copper can be incorporated into the matrix. In certain embodiments, magnesium can be incorporated into the matrix.

In certain embodiments, the ionic species, such as transition metal salts, can be catalytic. In certain embodiments, the catalytic component can catalyze such reactions as couplings, C—H activation, insertion reactions, decomposition, redox reactions, hydrogenation/dehydrogenation, and polymerization/depolymerization reactions.

In certain embodiments, the ionic species incorporated into the matrix, such as transition metal salts, can affect further structural and compositional modifications of the matrix and the colloidal assembly. Examples of such processes can include the rate and extent of the conversion of the colloids (e.g., removal of the colloids through conversion into CO₂), the rate and extent of the conversion of the matrix precursor from sol-to-gel, and precipitation of certain chemical species.

5. Additional Components

In certain embodiments, additional components can be included in the photonic structures, such as broadband absorbers, selective absorbers, light emissive species, components sensitive to light, heat, humidity, oxygen, and/or other chemicals.

In certain embodiments, the method incorporates additional components for color purification and saturation. In certain embodiments, the additional component is an absorbing component. In certain embodiments, the absorbing component is a broadband absorber. In certain embodiments, the absorbing component is a selective absorber. In certain embodiments, the absorbing component can be included within the matrix and/or the colloidal particles.

6. Method of Fabricating Photonic Structures

In certain embodiments, a method for fabricating the photonic structure is shown in FIG. 1H. As shown in 110 of FIG. 1H, colloidal particles (e.g., polymeric colloids), a precursor for the matrix material (e.g., metal oxide precursor), and an ionic species (e.g., transition metal precursors soluble in the matrix material or the precursor for the matrix material) are combined (e.g., in a liquid) to form a mixture.

As shown in 120 of FIG. 1D, in certain embodiments, the self-assembly of the colloidal particles and the solidification of the matrix precursor components result in the formation of a photonic structure.

In certain embodiments, additional components are combined in 110.

In certain embodiments, the liquid is aqueous or organic. In certain embodiments, the liquid is water.

In certain embodiments, a method for fabricating the photonic structure combines colloidal particles (e.g., polymeric colloids) and ionic species (e.g., transition metal salts), and does not include a matrix precursor.

In certain embodiments the photonic structure is self-assembled on a substrate. In certain embodiments the substrate on which the self-assembly takes place can be flat or curved. In certain embodiments the substrate for the self-assembly can contain additional topographical features, such as indentations and protrusions facilitating the formation of the photonic structures in specific shapes. The topographical features can be of sub-micrometer and/or larger dimensions.

In certain embodiments, the photonic structure is self-assembled in confined volumes. In certain embodiments, the photonic structure is self-assembled in a droplet. In certain embodiments, the photonic structure is self-assembled in a confined chamber to form brick-like shapes.

In certain embodiments, the photonic structure can be further processed to remove the colloidal particles, leaving behind only the matrix materials including the ionic species and/or precipitates. The processing methods can include calcination, dissolution, etching, evaporation, sublimation, phase-separation, and combinations thereof.

In certain embodiments, the photonic structure can be further processed to remove the ionic species leaving behind the colloidal structure and/or other matrix material free of the ionic species. The processing methods can include calcination, dissolution, etching, evaporation, sublimation, and combinations thereof.

Overall, the complexity of the interactions between the self-assembling species is significantly higher in the case of the co-assembly approach as compared to the stepwise one, making the development of the co-assembly approach more challenging. The advantages of finding solutions compatible with the co-assembly approach are substantially higher since they allow a broader range of possible structures and can reduce the amount of synthetic effort.

7. Ordering of the Photonic Structures

In certain embodiments, controlling the type, amount and/or valence states of the ionic species can lead to different ordering of the colloid-based photonic structures. In certain embodiments, the type, amount and/or valence states of the ionic species can affect the crystallinity of the photonic structure.

In certain embodiments, changing the type of ionic species incorporated into the photonic structure can change the ordering of the photonic crystal from a well-ordered system (e.g., single-crystalline) to a disordered system (e.g., glass-like).

In certain embodiments, changing the valence state of the ionic species incorporated into the photonic structure can change the ordering of the photonic crystal from a well-ordered system (e.g., single-crystalline) to a disordered system (e.g., glass-like).

In certain embodiments, changing the amount of the ionic species incorporated into the photonic structure can change the ordering of the photonic crystal from a well-ordered system (e.g., single-crystalline) to a disordered system (e.g., glass-like). In certain embodiments, the photonic structure is less crystalline with increasing concentrations of the ionic species.

In certain embodiments controlling the character (e.g., size, charge, polarity, specific affinity, and concentration) of the surface functional groups on the colloidal particles can lead to a different ordering of the photonic structures.

In certain embodiments, the photonic structure is single crystalline.

In certain embodiments, the photonic structure is polycrystalline.

In certain embodiments, the photonic structure is glass-like.

8. Optical Properties

In addition to allowing control over the degree of order, the spectroscopic properties (e.g., the visible appearance) of the photonic structure can be controlled.

In certain embodiments, incorporation of the ionic species and/or precipitates thereof can lead to different optical properties. For instance, due to the changes in the ordering of the photonic structure, highly iridescent (i.e., a single-crystalline photonic structure) to non-iridescent uniform color (i.e., a glass-like photonic structure) can be obtained.

In certain embodiments the ionic species can introduce additional optical effects inherent to the ions, such as absorbance, emission, and combinations thereof.

In certain embodiments, changing the type of ionic species incorporated into the photonic structure can change the optical properties of the photonic structure. For example, changing the ionic species from an absorbing salt, such as cobalt salt, to a non-absorbing salt, such as a magnesium salt, leads to the alteration of the order/iridescence without introducing a visible light-absorbing component.

In certain embodiments, changing the valence state of the ionic species incorporated into the photonic structure can change the optical properties of the photonic structure. In certain embodiments, the oxidation state of the transition metal salt affects the color of the photonic structure. In certain embodiments, different oxidation states of the same metal (e.g., cobalt) can result in different colored photonic structures (e.g., blue or red). In certain embodiments, different oxidation states of the same metal can result in different colored photonic structures, even though the order of the photonic structures is the same.

In certain embodiments, changing the crystal structure of the products of the ionic species incorporated into the photonic structure can change the optical properties of the photonic structure. In certain embodiments, the crystal structure of the resulting oxides of the transition metal salt affects the color of the photonic structure. In certain embodiments, different crystal structures of the same metal oxide (e.g., cobalt oxide) can result in different colored photonic structures (e.g., blue or greenish-grey). In certain embodiments, different crystal structures of the products of the same metal can result in different colored photonic structures, even though the order of the photonic structures is the same.

In certain embodiments, changing the amount of the ionic species incorporated into the photonic structure can change the optical properties of the photonic structure. For example, increasing the amount of ionic species can lead to a greater degree of disorder, leading to less iridescent optical effects.

In certain embodiments, the photonic structure is spectrally purified, i.e., the unwanted reflections are being selectively reduced while the target spectral components are being less altered. For example, incorporating tetrahedral cobalt species into photonic structures suppresses green, yellow, and red scattering, leaving a purer blue reflectance.

In certain embodiments, the photonic structure is color saturated, i.e., the spectral parts contributing to the addition of white component in the resulting color are suppressed.

In certain embodiments, the photonic structure is spectrally modified. In certain embodiments, the photonic structure is iridescent. In certain embodiments, the photonic structure exhibits controllable angle-dependent optical properties. In certain embodiments, the controllable angle-dependent optical properties comprise spectral shifts. In certain embodiments, the controllable angle-dependent optical properties comprise color travel. In certain embodiments, the controllable angle-dependent optical properties comprise sparkle. In certain embodiments, the controllable angle-dependent optical properties comprise hue. In certain embodiments, the controllable angle-dependent optical properties comprise glare. In certain embodiments, the controllable angle-dependent optical properties comprise gloss. In certain embodiments, the controllable angle-dependent optical properties comprise luster.

9. Structural Stability

In certain embodiments, controlling the type, amount, oxidation states, and/or valence states of the ionic species can lead to different ordering of the photonic structures, which in turn can lead to control of the desired structural stability. For example, a single crystalline photonic structure can be more brittle as compared to a glass-like photonic structure, with the single crystalline structure having a higher tendency for cracks to propagate along the crystalline planes. In contrast, the glass-like photonic structure does not have well-defined cleavage planes so it may be less brittle as formation of cracks may require additional force.

In certain embodiments, controlling the type, amount, oxidation state, and/or valence states of the ionic species can lead to different ordering of the photonic structures, which in turn can lead to control of the desired temperature stability and/or dissolution properties. For example, the dissolution kinetics of a crystalline structure can be anisotropic (i.e., proceed at different rates along different crystallographic directions) and proceed at a different rate as compared to polycrystalline and amorphous structures.

10. Applications

In certain embodiments, the photonic structure is useful as a structural pigment. In certain embodiments, the photonic structure is useful in sensors. In certain embodiments, the photonic structure is useful in catalysis. In certain embodiments, the photonic structure is useful in catalytic supports. In certain embodiments, the photonic structure is useful in photoactive catalysts. In certain embodiments, the photonic structure is useful in coherent scattering media. In certain embodiments, the photonic structure is useful in light emitters. In certain embodiments, the photonic structure is useful in random lasing. In certain embodiments, the photonic structure is useful in electromagnetic filters. In certain embodiments, the photonic structure is useful in optical applications, such as smart displays or other electrochromic materials. In certain embodiments the control over the optical properties and/or structural stability makes the colloidal assembly useful for preparation of cosmetic, pharmaceutical and edible products. In certain embodiments, the photonic structure is useful in drug delivery. In certain embodiments, the photonic structure is useful in fluidic devices. In certain embodiments, the photonic structure is useful in tissue engineering. In certain embodiments, the photonic structure is useful in membranes. In certain embodiments, the photonic structure is useful as a support media. In certain embodiments, the photonic structure is useful in filtration. In certain embodiments, the photonic structure is useful in sorption/desorption. In certain embodiments, the photonic structure is useful as a catalytic medium or support. In certain embodiments, the photonic structure is useful in acoustic devices. In certain embodiments, the photonic structure is useful in energy storage. In certain embodiments, the photonic structure is useful in batteries. In certain embodiments, the photonic structure is useful in fuel cells. In certain embodiments, the photonic structure is useful in fabrication of patterned structures.

### EXAMPLES

The following examples further describe and demonstrate embodiments within the scope of the present invention. The examples are given solely for the purpose of illustration and are not to be construed as limitations of the present invention, as many variations thereof are possible without departing from the spirit and scope of the invention.

### Example 1: Formation of Photonic Microspheres with Various Degrees of Disorder

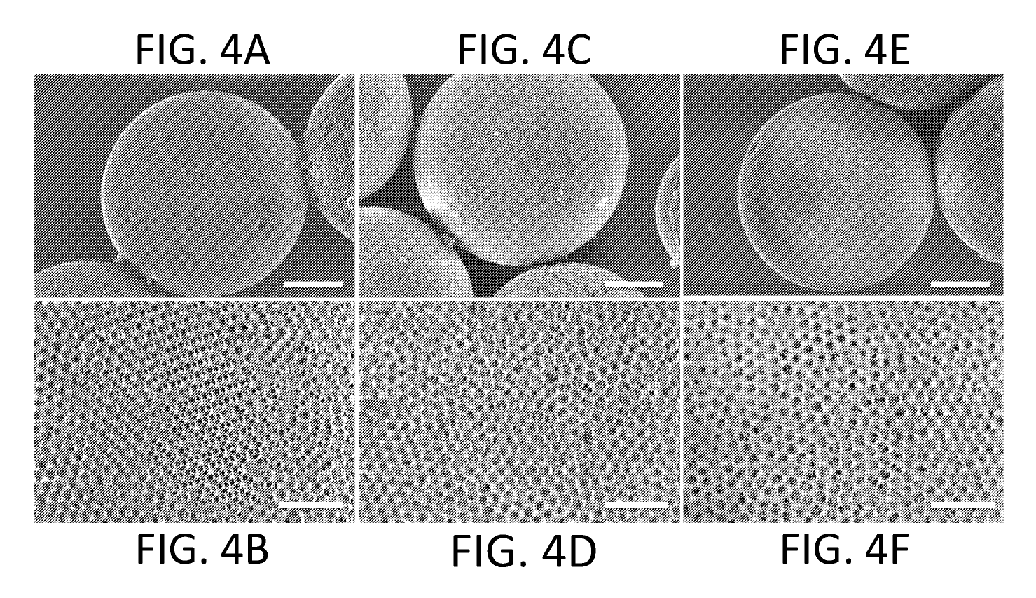

Silica and titania inverse opal microspheres with controllable degree of disorder were produced by the co-assembly method disclosed herein, wherein the coassembly mix was confined within emulsion droplets generated by a microfluidic device. Metal oxide nanocrystals ˜1 wt-% were combined with PEG, carboxylate, or sulfonate capped polystyrene spheres (200-700 nm˜1.5 wt-%) and with cobalt nitrate of various concentrations. Representative SEM images of silica photonic spheres with increasing concentrations of added cobalt nitrate (0 mM, 0.1 mM, and 0.2 mM from left to right) are shown in FIGS. 4A-4F. The scale bars at the top row images correspond to 5 μm, and the scale bars of the bottom row correspond to 1 μm. FIGS. 4A and 4B correspond to the 0 Mm concentration, FIGS. 4C and 4D correspond to the 0.1 Mm concentration, and FIGS. 4E and 4F correspond to the 0.2 Mm concentration.

### Example 2: Formation of Inverse Opal Powders

Tetraethylorthosilicate (TEOS) was prehydrolyzed by adding 1000 μL of TEOS to a mixture containing 800 μL of methanol and 460 μL of water followed by 130 μL of a concentrated hydrochloric acid.

162 μL of PEG-stabilized 244 nm polystyrene colloids (PDI 5%) and 31.5 μL of the prehydrolyzed solution of TEOS were added to a glass vial containing 10 mL of deionized water. Then 5 or 10 μL of a 1.28M solution of cobalt nitrate (or nickel sulfate, or copper nitrate) was added in order to obtain a concentration of 0.64 or 1.28 mM (10 or 20 mol % with respect to the silicon-containing molecular units), respectively.

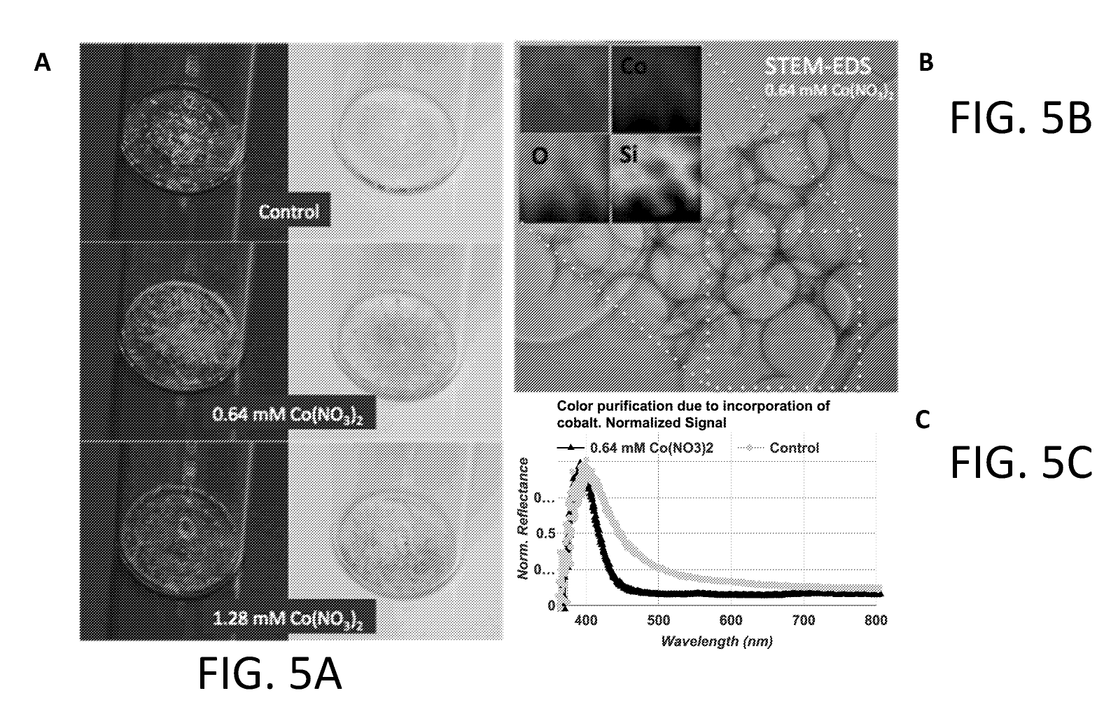

As shown in FIGS. 5A-C, inverse opal powders loaded with increasing amounts of cobalt (i.e., 0 mM Co(NO₃)₂, 0.64 mM Co(NO₃)₂, and 1.28 mM Co(NO₃)₂) resulted in an increased color saturation of the samples. Increased color saturation is emphasized by improved visibility of the samples on white backgrounds.

The sample containing 0.64 mM Co(NO₃)₂ (i.e., cobalt is 10 mol % with respect to the silicon-containing molecular units) was structurally and chemically analyzed by Transmission Electron Microscopy (TEM) and Scanning Transmission Electron Microscopy-Energy Dispersive Spectroscopy (STEM-EDS) elemental composition in FIGS. 5B and 5C. STEM-EDS indicated that Cobalt, Silicon, and Oxygen were homogeneously distributed within the matrix.

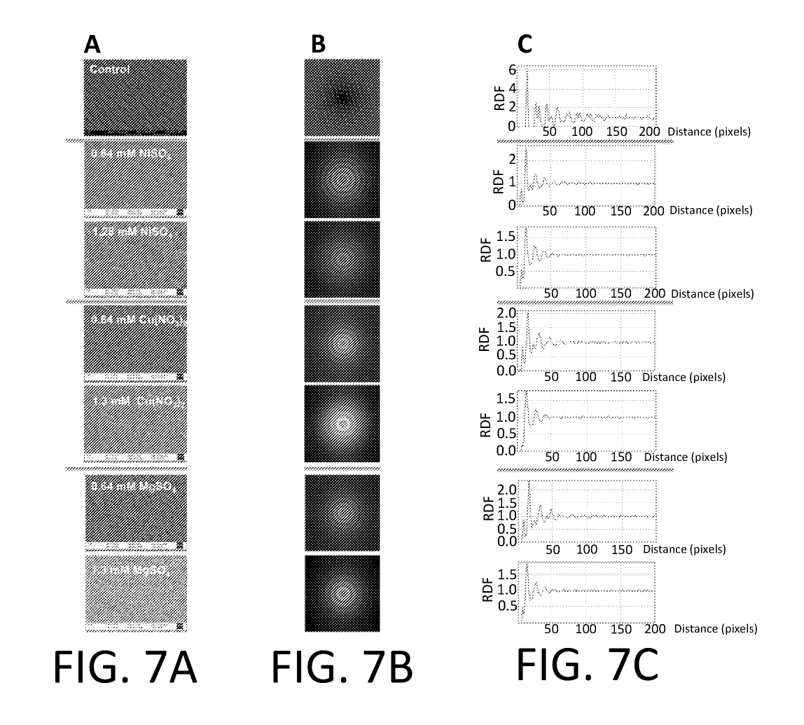

Incorporation of ionic species, such as cobalt, nickel, magnesium, and copper, can result in structures/morphologies exhibiting various degrees of order. SEM images of samples containing various amounts of Co(NO₃)₂, NiSO₄, and Cu(NO₃)₂ are shown in FIG. 6A and FIG. 7A. Fourier Transformations of the SEM images in FIG. 6B and FIG. 7B. Radial distribution functions (RDF) calculated based on the SEM image analysis are shown in FIG. 6C and FIG. 7C. The profile of an RDF is characteristic of the translational symmetry of the system. A long oscillating RDF is characteristic of a highly ordered/crystalline assembly while a decrease in the degree of order/crystallinity will correlate to a shorter distance at which the oscillations will undergo damping.

Upon review of the description and embodiments provided herein, those skilled in the art will understand that modifications and equivalent substitutions may be performed in carrying out the invention without departing from the essence of the invention. Thus, the invention is not meant to be limiting by the embodiments described explicitly above.

What is claimed is:

1. A process comprising:
combining a colloidal particle, a matrix material precursor, and an ionic species in a liquid to form a mixture, wherein the ionic species is dispersed or solubilized in the matrix material precursor; and
converting the mixture to a solid to form a photonic structure comprising a matrix that includes a matrix material surrounding said colloidal particle.

2. The process of claim 1, wherein said matrix comprises said ionic species.

3. The process of claim 1, wherein said matrix comprises precipitates of said ionic species.

4. The process of claim 1, wherein said liquid is aqueous or organic.

5. The process of claim 1, wherein said converting comprises hydrolyzing.

6. The process of claim 1, wherein said matrix material precursor comprises a metal oxide or mixed-metal oxide.

7. The process of claim 6, wherein said metal oxide comprises a silicon oxide, an aluminum oxide, a titanium oxide, a zirconium oxide, or a cerium oxide.

8. The process of claim 1, wherein said matrix material precursor comprises a hydrolysable compound.

9. The process of claim 8, wherein said hydrolysable compound comprises tetraethylorthosilicate (TEOS).

10. The process of claim 1, wherein said colloidal particle comprises a polymeric colloid, a ceramic colloid, a metallic colloid, a biopolymer colloid, or a supramolecular self-assembled colloid.

11. The process of claim 10, wherein said colloidal particle comprises a polymeric colloid.

12. The process of claim 10, wherein said polymeric colloid comprises a polystyrene or poly(methyl methacrylate) colloid.

13. The process of claim 1, wherein the concentration of ionic species is between 0.1 and 100 mol % of said matrix material surrounding said colloidal particle, wherein the mol % refers to the molecular ratio between the ionic species and the repeating molecular unit of the matrix material.

14. The process of claim 13, wherein the concentration of ionic species is between 1 and 50 mol % of said matrix material surrounding said colloidal particle.

15. The process of claim 14, wherein the concentration of ionic species is between 5 and 20 mol % of said matrix material surrounding said colloidal particle.

16. The process of claim 1, wherein said photonic structure is single crystalline.

17. The process of claim 1, wherein said photonic structure is less crystalline with increasing concentration of said ionic species.

18. The process of claim 17, wherein said photonic structure is polycrystalline.

19. The process of claim 14, wherein said photonic structure is glass-like.

20. The process of claim 1, wherein said photonic structure is crack free.

21. The process of claim 1, wherein said photonic structure is formed within a droplet.

22. The process of claim 21, wherein the droplet is between 0.1 μm and 10 mm.

23. The process of claim 22, wherein the droplet is between 1 μm and 10 mm.

24. The process of claim 23, wherein the droplet is between 1 μm and 1 mm.

25. The process of claim 1, wherein said photonic structure is spectrally modified, color saturated, iridescent, or exhibits controllable angle-dependent optical properties.

26. The process of claim 25, wherein said controllable angle-dependent optical properties comprise spectral shifts, color travel, sparkle, hue, glare, gloss, or luster.

27. The process of claim 1, wherein said ionic species is a metal salt.

28. The process of claim 27, wherein said metal salt is a transition metal salt.

29. The process of claim 28, wherein said transition metal salt comprises a cobalt salt, a nickel salt, a copper salt, a manganese salt, or mixtures thereof.

30. The process of claim 29, wherein said transition metal salt comprises cobalt nitrate, nickel sulfate, copper nitrate, or mixtures thereof.

31. The process of claim 27, wherein said metal salt comprises a magnesium salt.

32. The process of claim 31, wherein said magnesium salt comprises magnesium sulfate.

33. The process of claim 1, wherein said photonic structure is useful in catalysis.

34. A photonic structure comprising:
a first component; and
a matrix component;
wherein said matrix component comprises dispersed or solubilized ionic species.

35. The photonic structure of claim 34, wherein said first component is a gas.

36. The photonic structure of claim 34, wherein said first component is a colloidal particle.

37. The photonic structure of claim 36, wherein said colloidal particle comprises a polymeric colloid, a ceramic colloid, a metallic colloid, a biopolymer colloid, or a supramolecular self-assembled colloid.

38. The photonic structure of claim 36, wherein said colloidal particle comprises a polymeric colloid.

39. The photonic structure of claim 38, wherein said polymeric colloid comprises a polystyrene or poly(methyl methacrylate) colloid.

40. The photonic structure of claim 34, wherein the concentration of said ionic species is between 0.1 and 100 mol % of said matrix component.

41. The photonic structure of claim 40, wherein the concentration of said ionic species is between 1 and 50 mol % of said matrix component.

42. The photonic structure of claim 41, wherein the concentration of said ionic species is between 5 and 20 mol % of said matrix component.

43. The photonic structure of claim 34, wherein said photonic structure is single crystalline.

44. The photonic structure of claim 34, wherein said photonic structure is polycrystalline.

45. The photonic structure of claim 34, wherein said photonic structure is glass-like.

46. The photonic structure of claim 34, wherein said photonic structure is crack free.

47. The photonic structure of claim 34, wherein said photonic structure is spectrally modified, color saturated, iridescent, or exhibits controllable angle-dependent optical properties.

48. The photonic structure of claim 47, wherein said controllable angle-dependent optical properties comprise spectral shifts, color travel, sparkle, hue, glare, gloss, or luster.

49. The photonic structure of claim 34, wherein said matrix component further comprises a metal oxide or mixed-metal oxide.

50. The photonic structure of claim 49, wherein said metal oxide comprises a silicon oxide, an aluminum oxide, a titanium oxide, a zirconium oxide, or a cerium oxide.

51. The photonic structure of claim 49, wherein said metal oxide comprises a hydrolysable compound.

52. The photonic structure of claim 51, wherein said hydrolysable compound comprises tetraethylorthosilicate (TEOS).

53. The photonic structure of claim 34, wherein said ionic species is a metal salt.

54. The photonic structure of claim 53, wherein said metal salt is a transition metal salt.

55. The photonic structure of claim 54, wherein said transition metal salt comprises a cobalt salt, a nickel salt, a copper salt, a manganese salt, or mixtures thereof.

56. The photonic structure of claim 54, wherein said transition metal salt comprises cobalt nitrate, nickel sulfate, copper nitrate, or mixtures thereof.

57. The photonic structure of claim 53, wherein said metal salt comprises a magnesium salt.

58. The photonic structure of claim 57, wherein said magnesium salt comprises magnesium sulfate.

59. The photonic structure of claim 34, wherein said photonic structure is useful in structural pigments, electromagnetic filters, sensors, photoactive catalysts, coherent scattering media, light emitters, random lasing, or other optical applications, such as smart displays or other electrochromic materials.

60. The photonic structure of claim 34, wherein said photonic structure is useful for the preparation of cosmetic, pharmaceutical and edible products.

61. The photonic structure of claim 34, wherein said photonic structure is useful in drug delivery, fluidic devices, tissue engineering, membranes, filtration, sorption/desorption, or support medium.

62. The photonic structure of claim 34, wherein said photonic structure is useful as a catalytic medium or support.

63. The photonic structure of claim 34, wherein said photonic structure is useful in energy storage, batteries, or fuel cells.

64. The photonic structure of claim 34, wherein said photonic structure is useful in acoustic devices.

65. The photonic structure of claim 34, wherein said photonic structure is useful in fabrication of patterned structures.
